(19) United States
(12) Patent Application Publication
(10) Pub. No.: US 2007/0121926 A1
(43) Pub. Date: May 31, 2007

(54) Double-talk detector for an acoustic echo canceller

(76) Inventors: Thierry Le Gall, Villeneuve Loubet (FR); Laurent Le-Faucheur, Antibes (FR)

Correspondence Address: TEXAS INSTRUMENTS INCORPORATED, P O BOX 655474, M/S 3999, DALLAS, TX, 75265, US

(21) Appl. No.: 11/364,529

(22) Filed: Feb. 27, 2006

(30) Foreign Application Priority Data
Nov. 4, 2005 (EP) 05292337.2

(51) Int. Cl. H04M 9/08

(52) U.S. Cl. 379/406.01

(57) ABSTRACT

A system for canceling echo in a telephonic device includes an adaptive IR filter and a non-adaptive IR filter. The adaptive filter modifies its weights according to a first echo modified signal which mixes the near end signal with the output of the adaptive filter. A portion of these weights are used to detect either a single talk state or a double talk state. During single talk states, the output of the adaptive filter mixed with the near end signal will be used as the uplink signal. In double talk situations, the non-adaptive IR filter, which receives its weights from the adaptive filter during single talk situations, will be mixed with the near end signal to produce the uplink signal.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to telecommunication circuits and, more particularly, to a double-talk detector for an acoustic echo canceller.

2. Description of the Related Art

In telephone communication, and particularly in mobile phones, the clarity of a conversation is of significant importance. There are many factors that contribute to unintended noise during a conversation; one primary factor is echoing.

FIG. 1 illustrates the cause of echoing. Whenever a loudspeaker sits near a microphone, such as in a telephone, some part of the downlink far end signal (FES) is reflected from the loudspeaker 10 to the microphone 12. The various reflections are referred to as the “echo path” or “channel”. Sound from the echo channel is added to the near end signal (NES) in the uplink. This acoustic phenomenon is due to the multiple reflections of the loudspeaker output signal in the near end speaker environment.

The multiple reflections at the near end are transmitted back to the far end. Thus, the user at the far end hears his voice delayed and distorted by the communication channel—this is known as the echo phenomenon. The longer the channel delay and the more powerful the reflections, the more annoying the echo becomes in the far end, until it makes the natural conversation impossible.

FIG. 2 illustrates a basic block diagram of a prior art scheme to improve the audio service quality by reducing the effect of acoustic echoing, a signal processing module, the Acoustic Echo Canceller (AEC) 14, is currently implemented in the mobile phones.

In operation, the AEC 14 is an adaptive finite impulse response (AFIR) filter which mathematically mimics the echo channel. Thus, as shown in FIG. 2, for an echo channel which can be described by function H(z), the resultant acoustic echo is y(n). The AEC 14 defines a mathematical model, Ĥ(z), of the echo channel. The AEC 14 receives the far end signal s(n) and generates a correction signal ŷ(n). The output of the microphone, v(n), includes the echo channel, y(n), the users voice, u(n), and noise, n₀(n). The output of the AEC 14 (the echo correction signal ŷ(n)) is mixed with the near end signal (the output of microphone 12) at mixer 16. So long as ŷ(n) is a close approximation to y(n), the AEC 14 will eliminate or greatly reduce the affects of the echo channel at the uplink. It should be noted that the various signals described herein are digital signals, and are processed in digital form. It also should be noted that while the specification shows ŷ(n) being subtracted from the near end signal at mixer 16, the output of AEC 14 could be −ŷ(n), and thus the output of AEC 14 could be added with the near end signal at mixer 16 with the same result.

The AEC 14 is an adaptive filter. The echo compensated signal e(n) is fed back to the AEC 14. The AEC 14 adjusts the weights (also referred to as “taps” or “coefficients”) of the mathematical model Ĥ(z) responsive to the feedback to more closely conform to the actual acoustics of the echo channel. Methods of updating the weights are well known in the art, such as NLMS (Normalized Least Mean Square) adaptation or AP (Affine Projection) algorithm. Theoretically, the acoustic echo cancellation problem can be seen as the identification and the tracking of an unknown time varying system.

However, when the near end speaker and the far end speaker are talking at the same time, the adaptation of the AEC 14 is disturbed because the near end signal is uncorrelated with the far end signal. Consequently, the adaptive digital linear filter diverges far from the actual impulse response of the system echo channel H(z) and the AEC 14 no longer efficiently removes the echo in the uplink. Moreover, the near end speech signal is distorted by ŷ(n) and the quality of the communication is highly degraded by the AEC 14.

FIG. 3 illustrates a basic block diagram of a prior art system to prevent the AEC divergence during the double talk situations. This embodiment uses an additional component, the Double-Talk Detector (DTD) 18, in conjunction with the AEC 14. The purpose of the DTD 18 is to detect double-talk situations to deliver a command signal which freezes or slows down the AEC adaptation during the double-talk situation. Hence, based on the received far end signal, s(n), and the near end signal, v(n), the DTD determines whether a double talk situation is present. If so, the AEC 14 is notified. The AEC 14 includes and adaptation algorithm, 21, which under normal situations adapts the weights of filter 22, which implements Ĥ(z), based on the received far end signal, s(n), and the echo compensated signal e(n). Once a double-talk situation is detected further adaptations to the weight vector for filter 14 are halted or attenuated.

A system of the type shown in FIG. 3 requires significant resources. The conventional solutions in the temporal domain are generally based on energy power estimates, such as described in U.S. Pat. No. 6,608,897 or cross-correlation criterion using the uplink, downlink and the AEC error signal (Double-Talk Detection Statistic), as described in U.S. Pat. Pub. 2002/126834. In the frequency domain, the spectral or the energy distance between the far end signal and the near end signal criterion is used in U.S. Pat. Pub. 2003/133,565. In this publication, the double-talk detector signal is mainly used to freeze or to reduce the AEC adaptation during the double-talk situations.

Another solution in the time domain, shown in U.S. Pat. No. 6,570,986, uses multiple filters and selects one or the other filter from which to calculate a squared norm from an entire filter weight vector, depending upon the current state.

The prior art methods are processing intensive and subject to errant detections as the phone is moved. Therefore a need has arisen for an efficient and accurate method and apparatus for echo cancellation in view of double talk situations.

### BRIEF SUMMARY OF THE INVENTION

In a first aspect of the present invention, wherein a far end signal received by a telephonic device is acoustically coupled to a near end signal transmitted by the telephonic device, echo noise is canceled by generating a first echo cancellation signal from the far end signal in an adaptive impulse response filter and generating a second echo cancellation signal from the far end signal in a non-adaptive impulse response signal using weights received from the adaptive impulse response filter. Either a single talk state or a double talk state is detected in the near end signal and either the first echo cancellation signal or the second cancellation signal is applied to the near end signal responsive to the detected state.

This aspect of the invention allows the adaptive filter to remain adaptive and divergent during double talk periods for simplified determination of double talk situations using the weights of the adaptive IR filter.

In a second aspect of the present invention, wherein a far end signal received by a telephonic device is acoustically coupled via an echo path to a near end signal transmitted by the telephonic device, a double talk state is detected by generating a first echo cancellation signal from the far end signal in an adaptive impulse response filter, wherein said adaptive impulse response filter has weights that are modified responsive to an echo compensated signal mixing the near end signal with the first echo cancellation signal. An approximation of an impulse response energy gradient using a portion of the weights is calculated and a detection signal indicating either a double talk or a single talk state is generated responsive to the approximation.

This aspect of the invention provides for determination of double talk situations using simplified mathematical and logical operations conducive to implementation by a DSP (digital signal processor). Also, this aspect of the invention discriminates between double talk situations and echo path variations, where divergence between the adaptive filter weights and an accurate echo path model occur due to changes in the echo path.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates causes of acoustic echoing in a communication system;

FIG. 2 illustrates a basic block diagram of a prior art scheme to improve the audio service quality by reducing the effect of acoustic echoing;

FIG. 3 illustrates a basic block diagram of a prior art system to prevent the AEC divergence during the double talk situations;

FIG. 4 illustrates a block diagram of an embodiment of the present invention;

FIG. 5 illustrates a three dimensional graph illustrating impulse responses for a NLMS filter during single talk and double talk situations;

FIG. 6 illustrates a three dimensional graph showing impulse responses for an auxiliary filter used in the circuit of FIG. 4;

FIG. 7 illustrates a graph showing AEC output and DTD detection in the circuit of FIG. 4; and

FIG. 8 illustrates a telephone using the AEC system of FIG. 4.

### DETAILED DESCRIPTION OF THE INVENTION

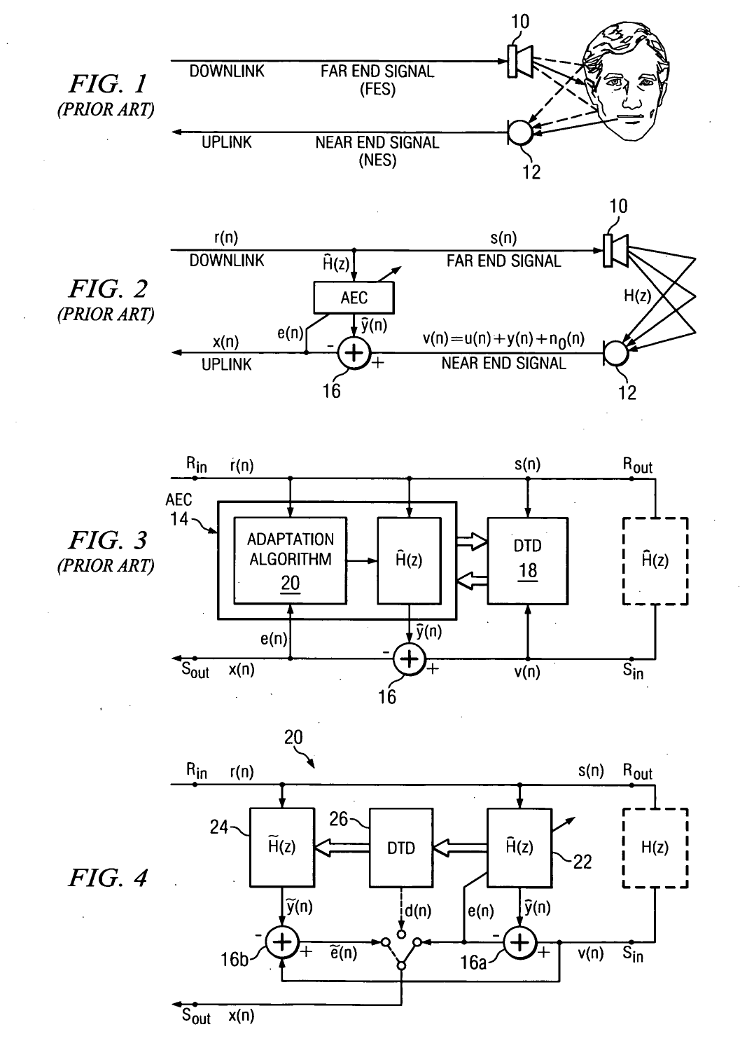

The present invention is best understood in relation to FIGS. 1-8 of the drawings, like numerals being used for like elements of the various drawings.

FIG. 4 illustrates an embodiment of an echo cancellation circuit 20 which substantially improves echo cancellation over the prior art. As before, the echo channel is represented by H(z), and an AEC (AFIR) filter 22 receives the far end signal s(n) and generates an echo correction signal ŷ(n) which is subtracted from v(n) at mixer 16a. The output of mixer 16a is the echo compensated signal, e(n). An auxiliary filter 24 receives the far end signal s(n) and generates an echo correction signal \tilde{y}(n) which is subtracted from v(n) at mixer 16a to produce echo compensated signal \tilde{e}(n). Auxiliary filter 24 periodically receives and stores the AEC adapted impulse response weights corresponding to Ĥ(z) through the double talk detector (DTD) 26. Auxiliary filter 24 is updated only during single-talk periods, as detected by DTD 26. DTD. 26 uses the weight vector from filter 22 to detect double talk and single talk situations. Depending upon whether a single talk or a double talk situation is detected, DTD 26 selects either e(n) or \tilde{e}(n) for output.

In operation, filter 22 operates adaptively, i.e., responsive to e(n), regardless of whether a single talk or double talk situation exist. DTD 26 continuously calculates a decision signal based solely on the weight components of the weight vector of filter 22 to determine whether the present state is of v(n) is single talk or double talk. During single talk periods, d(n) is set to select e(n) for output and, periodically, the weight vector of filter 22 is stored to filter 24. During double talk periods, d(n) is set to select \tilde{e}(n) for output; during this time the weight vector for filter 24 is static; but the weight vector for filter 22 will continue to be adaptive to e(n), and, hence, diverging due to the double talk. Thus, during double talk situations, \tilde{H}(z) is static at the point of the last transfer of a weight vector from Ĥ(z). When DTD 26 detects a transition from a double talk situation to a single talk situation, the weight vector from filter 24 is stored in filter 22 to return Ĥ(z) to a value which should be close to H(z).

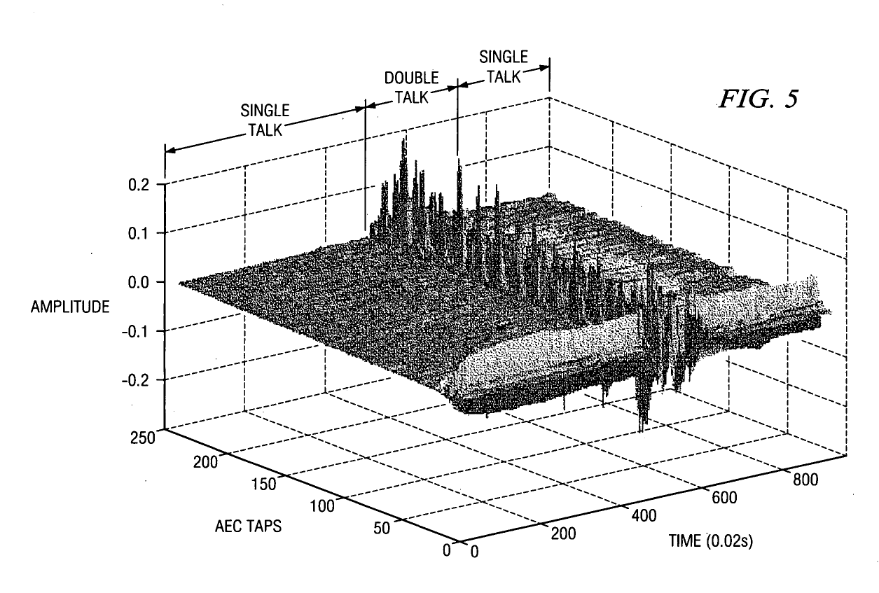

FIG. 5 illustrates an impulse response for a NLMS AFIR filter 22 during a transition from a single talk state to a double talk state and back to single talk state. As can be seen, there is a severe disturbance induced by the double talk situation on the impulse response.

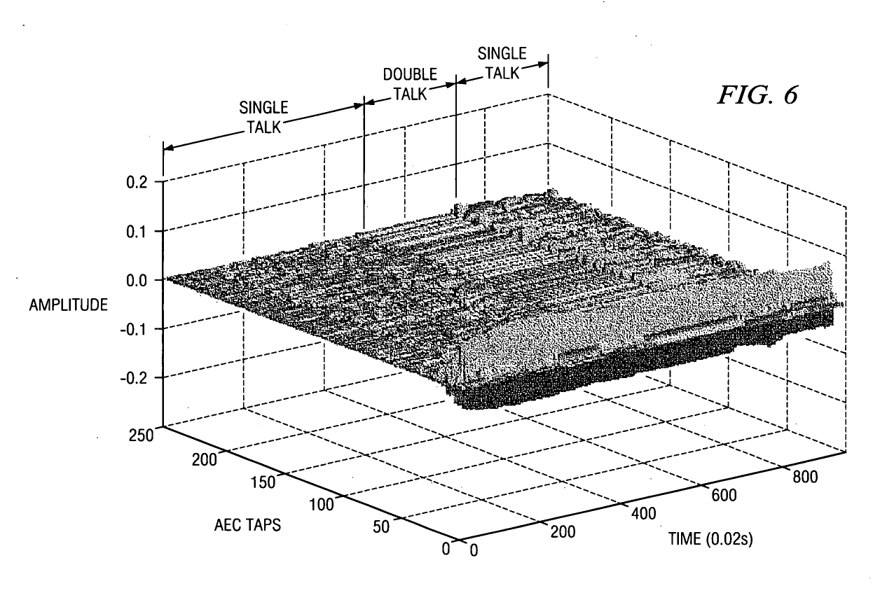

FIG. 6 illustrates the impulse response for a static IF filter 24 during a transition from a single talk state to a double talk state and back to single talk state. As can be seen, when a double talk situation is detected, the static auxiliary filter 24 has a non-divergent impulse response for performing echo cancellation.

As discussed above, the DTD 26 uses the IR energy gradient from AEC filter 22 to detect double talk situations. In the preferred embodiment, the DTD 26 uses only the second-half IR weights (i.e., the higher order weights) to perform the detection function. An energy gradient is approximated using a differential method and its absolute value is subjected to a low-pass iterative IIR (infinite impulse response) filter. The double talk decision is then made through a comparison between the decision signal and a predefined threshold. An embodiment for performing the detection is given below.

In the following equations, ĥ(n) is the AEC IR weight vector corresponding to the transfer function Ĥ(z), computed at the sampling time tₙ=t₀+nTₑ, where the initial time is t₀ and the sampling period is Tₑ.

ĥ(n)=[ĥ₀, . . . ,ĥ_{N-1]}^{T}∈z,900 ^{N×1}, where N is the AEC IR length and z,900 ^{N×1} denotes the real values in a vector of length N.

The AEC second-half IR energy at iteration n is computed as:

$${ɛ}_{\hat{h}} ( n ) = {\sum }_{i = \frac{N}{2}}^{N - 1} {\hat{h}}_{i}^{2} ( n )$$

The AEC IR gradient energy at iteration n is approximated using the differential energy with iteration n−1:
γ_{ĥ}(n)=|ε_{ĥ}(n)−ε_{ĥ}(n−1)|

The approximate gradient γ_{ĥ} is low-pass filtered to obtain the double-talk detector decision signal δ:

δ(n)=λδ(n−1)+(1−λ)γ_{ĥ}(n), with λ being a constant forgetting factor, generally between the values of 0.9 and 0.99 that allows the low pass filtering to be implemented in an iterative manner.

The double talk decision, d(n) at iteration n is decided using a comparison between the signal values βδ(n), where β is a gain factor, with a predefined decision threshold θ according to:

$$\{ \begin{matrix}d ( n ) \neq 0 , if βδ ( n ) \geq θ ⇒ double - talk situation \\ d ( n ) = 0 , if βδ ( n ) < θ ⇒ single - talk situation\end{matrix}$$

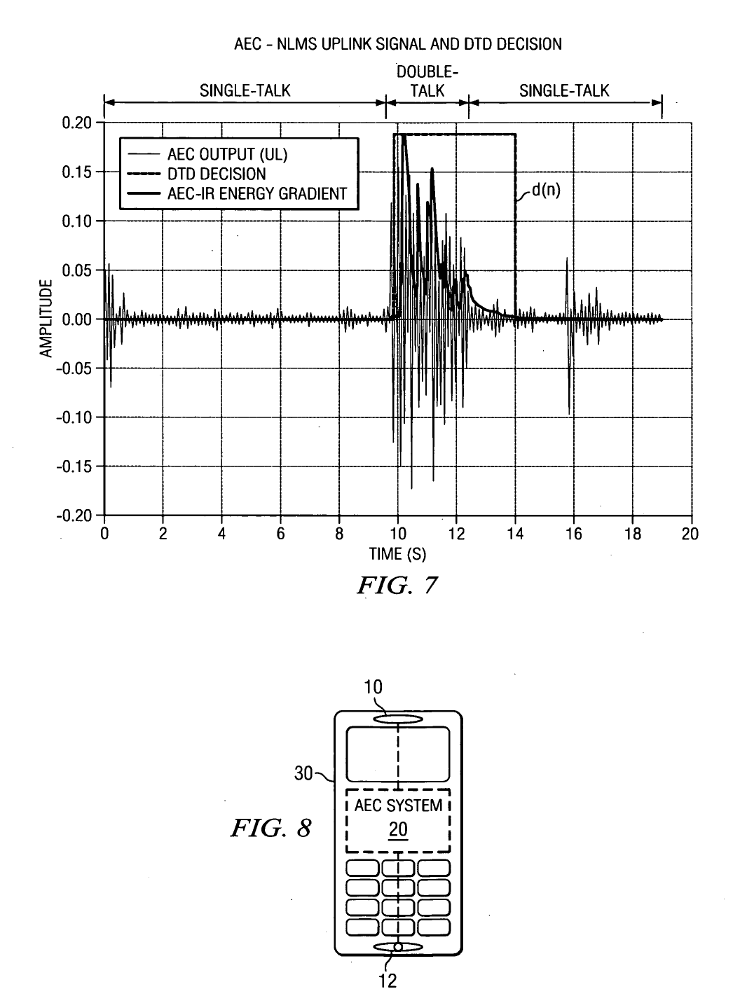

An example of the AEC output, AEC IR energy gradient and double talk decision are shown in FIG. 7.

The uplink signal, x(n), is selected from either the AEC IR filter 22 or the static auxiliary filter 24 dependent upon d(n):

$$\{ \begin{matrix}x ( n ) = \hat{e} ( n ) if d ( n ) = 1 \\ x ( n ) = e ( n ) if d ( n ) = 0\end{matrix}$$

Because the DTD 26 approximates the energy gradient along the time dimension of the impulse response energy along the taps dimension, rather than the full gradient energy, the computations needed to compute the double talk decision has a low computation complexity, using only multiply, accumulate and logical operations. The embodiment described above does not need the near end signal or far end signal to detect double talk situations. Further, the complexity of computation is reduced by using only the second half of the AEC IR weight vector. More complex operations, such as divisions and matrix inversions, are not necessary. This lends the computation to a DSP (digital signal processor) fixed point implementation. Further, the computation can be implemented in both sample-to-sample and block processing.

While described in connection with an NLMS adaptive IR filter, the embodiment could be used with LMS (Least Mean Square), AP (Affine Projection), or other filter in the temporal domain using an IR computation.

FIG. 8 illustrates a telephonic device, such as a mobile phone or smart phone, incorporating the AEC system 20 of FIG. 4.

The various components of the AEC system 20, including AEC filter 22, auxiliary filter 24, DTD 26 and mixers 16a and 16b can be implemented as multiple tasks on a single DSP.

In tests using a recorded database with artificial and real speech signals and propagation in real reverberant environments, the embodiment has shown to be noise resistant within a 5 to 20 db signal-to-noise ratio in both the uplink and the downlink. Also, this embodiment has the ability to discriminate between double-talk situations and echo path variations (EPVs). In an EPV, the echo path has changed, because the phone has moved, and thus Ĥ(z) must be modified to accommodate the new H(z). However, if an EPV is mistakenly etected as a double talk situation, the AEC filter 14 will be frozen (prior art) or the static auxiliary filter 24 is used for echo cancellation as described in connection with FIG. 4. In either case, mistaking an EPV for a double talk situation will delay cancellation of the echo adaptively.

Using the detection method described above, where only the second half of the AEC impulse response along the time dimension is used, EPVs are not generally mistaken for double talk situations, since an EPV generally affects the first half of the AEC impulse response along the time dimension, i.e.,

$${ɛ}_{\hat{h}} ( n ) = {\sum }_{i = 0}^{\frac{N}{2} - 1} {\hat{h}}_{i}^{2} ( n ) ,$$

while a double talk situation affects all the impulse response along the taps dimension (as shown in FIG. 5). Accordingly, the double talk detector described above is insensitive to EPVs, resulting in fewer false detections. It should be noted that while the upper half of the higher order weights are used to detect double talk situations in the preferred embodiment, it is expected that a significantly smaller number of the higher order weights could be used, such as the top quarter or eighth of the weights, with success. In general, using a smaller portion of the higher order weights will increase the insensitivity to EPVs, but may lessen the ability to recognize a double talk situation. Of course, the number of calculations decreases with the number of weights used. It would also be possible to have a programmable number of weights used in the calculation—the user or manufacturer could adjust the number of weights used as appropriate.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A method of canceling echo noise in a telephonic device wherein a far end signal received by the telephonic device is acoustically coupled to a near end signal transmitted by the device, comprising the steps of:
generating a first echo cancellation signal from the far end signal in an adaptive impulse response filter;
generating a second echo cancellation signal from the far end signal in a non-adaptive impulse response signal using weights received from the adaptive impulse response filter;
detecting either a single talk state or a double talk state in the near end signal;
generating an uplink signal comprising the near end signal mixed with either the first echo cancellation signal or the second cancellation signal responsive to the detected state.

2. The method of claim 1 wherein said detecting step comprises the step of detecting either a single talk state or a double talk state responsive to some or all of the weights the adaptive filter.

3. The method of claim 1 wherein said step of generating the second echo cancellation signal comprises the step of generating the second cancellation signal from the far end signal in a non-adaptive impulse response signal using weights received from the adaptive impulse response filter during single talk states.

4. The method of claim 1 and further comprising the step of restoring weights from the non-adaptive filter to the adaptive filter at the end of a double talk state.

5. A method of detecting a double talk state in a telephonic device wherein a far end signal received by the telephonic device is acoustically coupled via an echo path to a near end signal transmitted by the device, comprising the steps of:
generating a first echo cancellation signal from the far end signal in an adaptive impulse response filter, wherein said adaptive impulse response filter has weights that are modified responsive to an echo compensated signal mixing the near end signal with the first echo cancellation signal;
calculating an approximation of an impulse response energy gradient using a portion of the weights;
generating a detection signal indicating either a double talk or a single talk state responsive to the approximation.

6. The method of claim 5 wherein the calculating step comprises calculating an approximation of an impulse response energy gradient using an upper portion of the weights.

7. The method of claim 6 wherein said upper portion comprises one half or less of the weights.

8. A telephonic device comprising:
a loudspeaker for receiving a far end signal and generating an acoustic output signal;
a microphone for receiving an acoustic input, wherein said microphone will receive the acoustic output signal via a echo path;
circuitry for generating a first echo cancellation signal from the far end signal in an adaptive impulse response filter;
circuitry for generating a second echo cancellation signal from the far end signal in a non-adaptive impulse response signal using weights received from the adaptive impulse response filter;
circuitry for detecting either a single talk state or a double talk state in the near end signal; and
circuitry for applying either the first echo cancellation signal or the second cancellation signal to the near end signal responsive to the detected state.

9. The telephonic device of claim 8 wherein the adaptive filter has weights that are modified to accurately model the echo path and wherein the detecting circuitry comprises the circuitry for detecting either a single talk state or a double talk state responsive to a portion of the weights of the adaptive filter.

10. The telephonic device of claim 8 and further comprising circuitry for restoring weights from the non-adaptive filter to the adaptive filter at the end of a double talk state.

11. A telephonic device comprising:
a loudspeaker for receiving a far end signal and generating an acoustic output signal;
a microphone for receiving an acoustic input, wherein said microphone will receive the acoustic output signal via a echo path;
circuitry for generating a first echo cancellation signal from the far end signal in an adaptive impulse response filter, said adaptive impulse response filter having weights that are modified responsive to an echo modified signal comprising the near end signal mixed with the first echo cancellation signal;
circuitry for calculating an approximation of an impulse response energy gradient using a portion of the weights;
circuitry for generating a detection signal indicating either a double talk or a single talk state responsive to the approximation.
